(19) United States
(12) Patent Application Publication
(10) Pub. No.: US 2026/0189359 A1
(43) Pub. Date: Jul. 2, 2026

(54) A HARDWARE CONFIGURATION DESIGNED FOR THE EXECUTION OF ASCON CRYPTOGRAPHIC METHODS WHILE DEFENDING AGAINST SIDE-CHANNEL ATTACKS

(71) Applicant: PQSecure Technologies, LLC, Boca Raton, FL (US)

(72) Inventors: Abubakr Abdulgadir, Reston, VA (US); Luke Beckwith, Sterling, VA (US); Rami Elkhatib, Boca Raton, FL (US)

(73) Assignee: PQSECURE TECHNOLOGIES, LLC, Boca Raton, FL (US)

(21) Appl. No.: 19/141,833

(22) PCT Filed: Nov. 15, 2024
(86) PCT No.: PCT/US2024/056116

§ 371 Date: Jun. 20, 2025

(51) Int. Cl. H04L 9/00; H04L 9/06

(52) U.S. Cl. CPC H04L 9/003; H04L 9/0631

(57) ABSTRACT

A low-area hardware architecture to execute the ASCON cipher suite and resist side-channel attacks that have a co-processor having controllers, register file, a permutation operably configured to receive input from a multiplexor structure and execute ASCON permutation, an ASCON state register that can be optionally removed and substituted by the register layer inside the permutation unit, and XOR logic gates that are operably configured to receive input from the register file and the permutation unit and provide input to the multiplexor structure.

### FIELD OF THE INVENTION

The current invention pertains broadly to the area of hardware-based approaches and frameworks utilized in cryptographic devices, with emphasis on improving the efficiency and the side-channel attack security in such systems.

### BACKGROUND OF THE INVENTION

Authenticated cipher merges the services of confidentiality and authentication in a single algorithm. Traditionally, to provide these two services, two separate algorithms are used, one for confidentiality, and the other for authentication. Merging the two services opens the door for resource sharing resulting in a lightweight design. In the Internet-of-things (IoT), many applications require stringent power, energy, and cost constraints necessitating the use of lightweight ciphers. These applications include but are not limited to smart cards, secure boot, and secure firmware updates.

Additionally, since these IoT devices are usually deployed with little or no physical security, it is easy for adversaries to collect side-channel information such as power consumption and mount side-channel analysis (SCA) attacks such as differential power analysis (DPA). To thwart such attacks, many applications require the use of side-channel countermeasures such as masking.

Generally, lightweight ciphers are ciphers with low computational requirements which translates into low footprint and low power hardware implementations. These features make them attractive for the embedded IoT applications mentioned above.

Side-channel analysis is a severe class of attacks that uses information such as timing and power consumption to reveal secret data. In a practical example of a DPA side-channel attack, an adversary measures the power consumption of a cryptographic device then analyzes the traces and correlates the traces with values computed by the cryptographic algorithm to reveal secret keys.

Masking is a countermeasure used to resist side-channel attacks. In a masked implementation, each sensitive variable is split into randomized shares, and computations are performed on these shares without revealing the original secret variable. One of the most used models to analyze the security of masked circuits is the t-probing model. For a circuit to be t-probing secure, an adversary with t probes into the circuit should not be able to learn anything about the sensitive data. The circuit's security order is the maximum value of t for which the circuit is t-probing secure.

Glitches are unintended changes in the value of digital signals in a circuit before they stabilize at the end of a clock cycle. Gliches happen due to uneven delays in the combinational logic. It has been shown that glitches can cause information leakage in masked hardware design. Several attempts have been made to provide SCA resistance in the presence of glitches. Domain-oriented masking (DOM) is one of the masking techniques that are secure in the presence of glitches making it suitable for hardware implementations.

ASCON cipher suite is a family of lightweight cryptographic algorithms that can perform authenticated encryption with associated data (AEAD), hashing, and extensible output function (XOF). The US National Institute of Standards and Technology chose ASCON as the standard for lightweight applications. This selection is expected to be followed by wide adoption and usage of ASCON in secure products for decades to come.

For authenticated encryption, ASCON receives a key, a nonce, associated data (AD), and plaintext, and outputs ciphertext and an authentication tag. For authenticated decryption, ASCON receives a key, a nonce, associated data, ciphertext, and a tag, and outputs the plaintext if the authentication is successful. For hashing and XOF, ASCON receives blocks of the message and produces a 256-bit output or arbitrarily long output, respectively.

Internally, ASCON is based on duplex modes. It uses a 320-bit state organized as five 64-bit words. A permutation function operates on the state by performing multiple rounds and data is injected or extracted from the state. A permutation round consists of the application of round constant addition (RC), a nonlinear substitution (S-box), and linear diffusion (LD).

ASCON suite specification version 1.2 which was the submission to NIST provides two recommendations; the primary is ASCON-128, ASCON-Hash, and ASCON-XOF while the secondary recommendation is ASCON-128a, ASCON-HASHA, and ASCON-XOFA. These recommendations differ in block size and the number of permutation rounds.

ASCON operates in a sponge mode. Its operations include Initialization, Permutation, Absorb, and Squeeze. Initialization involves setting the state to the concatenation of an initialization vector (IV), nonce, key, and zeros in the case of AEAD or the concatenation of IV and zeros in the case of hashing and XOF then the permutation is applied 12 times. Absorb is the operation of injecting input data into the lower r bits of the state. The data is XORed into the lower r bits of the state in the case of encryption, hashing, and XOF. On the other hand, the lower r bits are replaced by the ciphertext in the case of decryption. In Squeeze, the lower r bits of the state are extracted and used to generate output.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments further and explain various principles and advantages all in accordance with the present invention.

FIG. 1 depicts prior art ASCON implementation with multiplexing logic to select state input;

FIG. 2 is a schematic representation of the innovative multiplexor structure for permutation state input in a cryptosystem, detailing the sequential selection process for the upper bits of the state input from various data sources such as ciphertext, associated data, IV, previous permutation output, and plaintext, followed by the decision logic for key, nonce, and further permutation output integration;

FIGS. 3-4 show unprotected ASCON-128 and ASCON-128a data flow and block diagram, respectively, showcasing the standard configuration without masking integration;

FIG. 5 depicts the ASCON data flow and block diagram indicating the replication of multiplexors, state register, and permutation blocks in accordance with the degree of masking applied in this invention; and

FIG. 6 shows prior art domain-oriented masking AND gate (DOM AND) this gate is used in the side-channel-protected ASCON.

### SUMMARY OF THE INVENTION

This invention presents a refined multiplexor architecture for selecting the ASCON permutation input that reduces the complexity typically associated with selecting the permutation input in each phase of ASCON. Traditional systems necessitate a 320-bit input that updates each round with a variety of data types such as key, nonce, initialization vector (IV), ciphertext, plaintext, or the output from a previous permutation. The invention streamlines this process by introducing a multi-tiered multiplexor structure. In the first tiers, the multiplexor selects from inputs derived from the key, nonce, and permutation output. In the second tier, the multiplexor selects from inputs derived from the key and the permutation output. In the third tier, the multiplexor selects from inputs derived from the ciphertext, associated data, IV, output from the previous permutation, and plaintext for the most significant bits of the state input, specifically the upper 64 or 128 bits in the case of ASCON-128 and ASCON-128a, respectively. This approach significantly simplifies the complexity of state input selection at each cryptographic round.

With the foregoing and other objects in view, there is provided, in accordance with the invention, an area-efficient cryptosystem hardware architecture operably configured to execute ASCON algorithms is disclosed that includes a computer chip including an ASCON block operably configured to execute ASCON algorithms, having at least one register file operably configured to store a plurality of ASCON algorithm input data, having a controller, having a three-tiered multiplexor structure that is operably configured, through the controller, to selectively receive from the plurality of ASCON algorithm input data and each generates permutation round input, and having a permutation module operably configured to receive the permutation round input from the three-tiered multiplexor structure, execute a permutation round, and to generate permutation round output for utilization in the execution of the ASCON algorithms.

In accordance with another feature, an embodiment of the present invention includes the at least one register file including the plurality of ASCON algorithm input data and having ciphertext, associated data, initialization vector, plaintext, key, and nonce.

In accordance with yet another feature, an embodiment of the present invention also includes a plurality of logic gates operably coupled to the three-tiered multiplexor structure and configured to receive at least one of the plurality of ASCON algorithm input data and the permutation round output.

In accordance with an additional feature, an embodiment of the present invention also includes a first XOR gate operably coupled to a first multiplexor of the three-tiered multiplexor structure, configured to receive at least one of the plurality of ASCON algorithm input data and the permutation round output, and configured to generate a first XOR gate output, wherein the first multiplexor is operably configured to selectively and directly receive from the plurality of ASCON algorithm input data in the at least one register file, directly from the permutation round output, and directly from the first XOR gate output to generate a first permutation round input, a second XOR gate operably coupled to a second multiplexor of the three-tiered multiplexor structure, configured to receive at least one of the plurality of ASCON algorithm input data and the permutation round output, and configured to generate a second XOR gate output, wherein the second multiplexor is operably configured to selectively and directly receive from the plurality of ASCON algorithm input data in the at least one register file, directly from the permutation round output, and directly from the second XOR gate output to generate a second permutation round input, and a third XOR gate operably coupled to a third multiplexor of the three-tiered multiplexor structure, configured to receive at least one of the plurality of ASCON algorithm input data and the permutation round output and configured to generate a third XOR gate output, wherein the third multiplexor is operably configured to selectively and directly receive from the plurality of ASCON algorithm input data in the at least one register file, directly from the permutation round output, and directly from the second XOR gate output to generate a third permutation round input, the first, second, and third permutation round input forming the permutation round input.

In accordance with yet another feature, an embodiment of the present invention also includes the first XOR gate is configured to receive a key and Permute output, the first multiplexor is operably configured to selectively and directly receive the nonce, the first XOR gate output, and the Permute output, the second XOR gate is configured to receive the key and the Permute output, the second multiplexor is operably configured to selectively and directly receive the key and the second XOR gate output and the Permute output, and the third XOR gate is configured to receive the plaintext or the associated data, and the Permute output, the third multiplexor is operably configured to selectively and directly receive the ciphertext, the initialization vector, the output of the third XOR gate, and the Permute output.

In accordance with a further feature of the present invention, the permutation round input is 320 bits numbered from 0 to 319, the first multiplexor is operably configured to generate the first permutation round input with bits numbered from 0 to 127, the second multiplexor is operably configured to generate the second permutation round input with bits numbered from 128 to 255, and the third multiplexor is operably configured to generate the third permutation round input with bits numbered from 256 to 319.

In accordance with yet another feature, an embodiment of the present invention also includes the permutation round input generated from the three-tiered multiplexor structure is 320 bits numbered from 0 to 319 and also includes a first multiplexor of the three-tiered multiplexor structure operably configured to generate a first permutation round input with bits numbered from 0 to 127, a second multiplexor of the three-tiered multiplexor structure operably configured to generate a second permutation round input with bits numbered from 128 to 255, and a third multiplexor of the three-tiered multiplexor structure operably configured to generate a third permutation round input with bits numbered from 256 to 319.

In accordance with a further feature, an embodiment of the present invention also includes the permutation module having a plurality of DOM AND gates internal to the permutation module and operably configured to receive the permutation round input during the permutation round and a plurality of pipeline registers internal to the permutation module and operably configured to receive and store the permutation round input during the permutation round.

In accordance with an exemplary feature of the present invention, the plurality of DOM AND gates and the plurality of pipeline registers are operably configured to receive the permutation round input without the permutation round input passing through a state register block.

In accordance with the present invention, an area-efficient cryptosystem hardware architecture is disclosed and that is also operably configured to execute ASCON algorithms and that includes a computer chip including an ASCON block operably configured to execute ASCON algorithms, having at least one register file operably configured to store a plurality of ASCON algorithm input data, having a controller, having a multiplexor structure operably configured through the controller to selectively receive from the plurality of ASCON algorithm input data and each generate permutation round input, and having a permutation module. The permutation module is operably configured to execute a permutation round, includes a plurality of DOM AND gates internal to the permutation module and operably configured to receive the permutation round input during the permutation round, includes a plurality of pipeline registers internal to the permutation module and operably configured to receive and store the permutation round input during the permutation round, and is operably configured to generate permutation round output for utilization in the execution of the ASCON algorithms.

In accordance with a further feature of the present invention, the plurality of DOM AND gates and the plurality of pipelined registers are operably configured to receive the permutation round input without the permutation round input passing through a state register block.

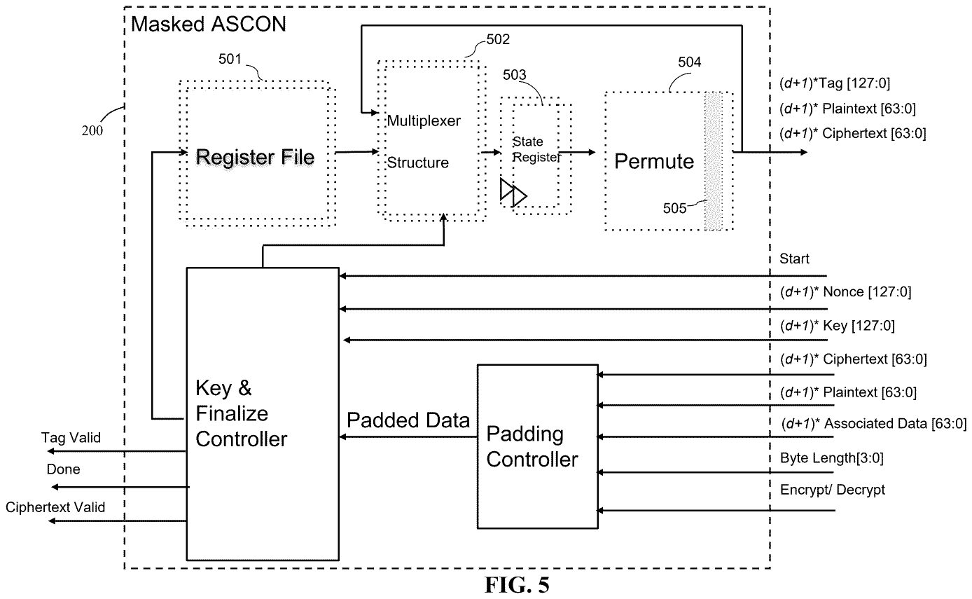

Another innovative aspect of this invention lies in the employment of the domain-oriented masked AND gates'internal registers to store the ASCON state. By leveraging this pipelined register layer instead of the conventional state register block shown in FIG. 5, the design achieves a reduction in the number of registers and latency typically required for traditional masked designs.

The cryptographic hardware architecture in this invention distinctively separates the control path from the masking path. Such an arrangement allows for scalable optimization of the area versus security trade-off, confined to the size of the datapath modules alone. These “modules” may be considered physical components that may be self-contained on a chip. This design ensures that the controllers remain unaffected in terms of resource allocation regardless of the degree of masking applied.

Although the invention is illustrated and described herein as embodied in a computer processing system and method for performing side-channel countermeasures, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic of the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “providing” is defined herein in its broadest sense, e.g., bringing/coming into physical existence, making available, and/or supplying to someone or something, in whole or in multiple parts at once or over a period of time. Furthermore, there is no intention to be bound by any expressed or implied theory presented in the preceding technical field, background, brief summary, or the following detailed description.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances, these terms may include numbers that are rounded to the nearest significant figure. The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or another sequence of instructions designed for execution on a computer system. The terms “summation” and “addition” are used interchangeably herein. The terms “data share” and “share” are also used interchangeably herein.

### DETAILED DESCRIPTION

While the specification concludes with claims defining the features of the invention that are regarded as novel, it is believed that the invention will be better understood from a consideration of the following description in conjunction with the drawing figures, in which reference numerals are carried forward. It is to be understood that the disclosed embodiments are merely exemplary of the invention, which can be embodied in various forms.

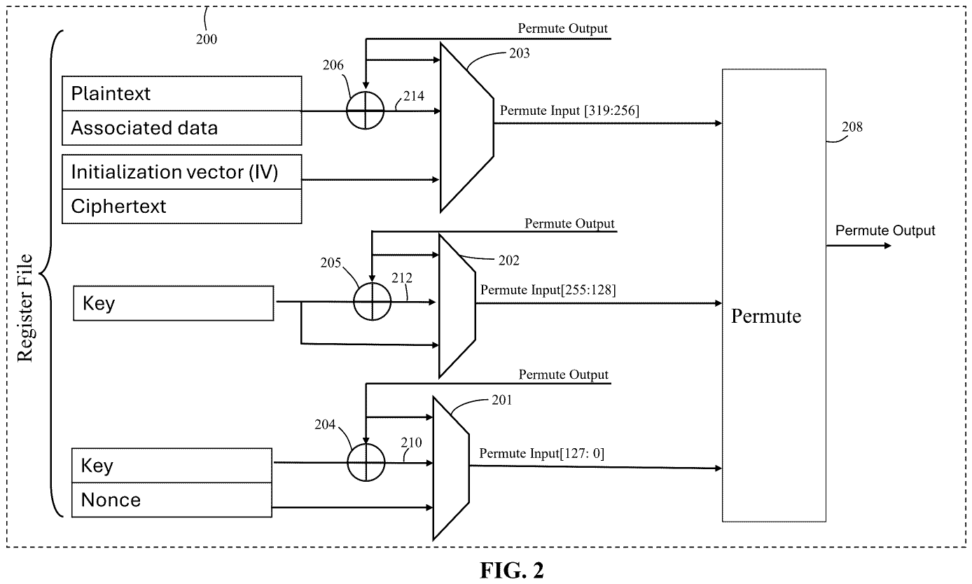

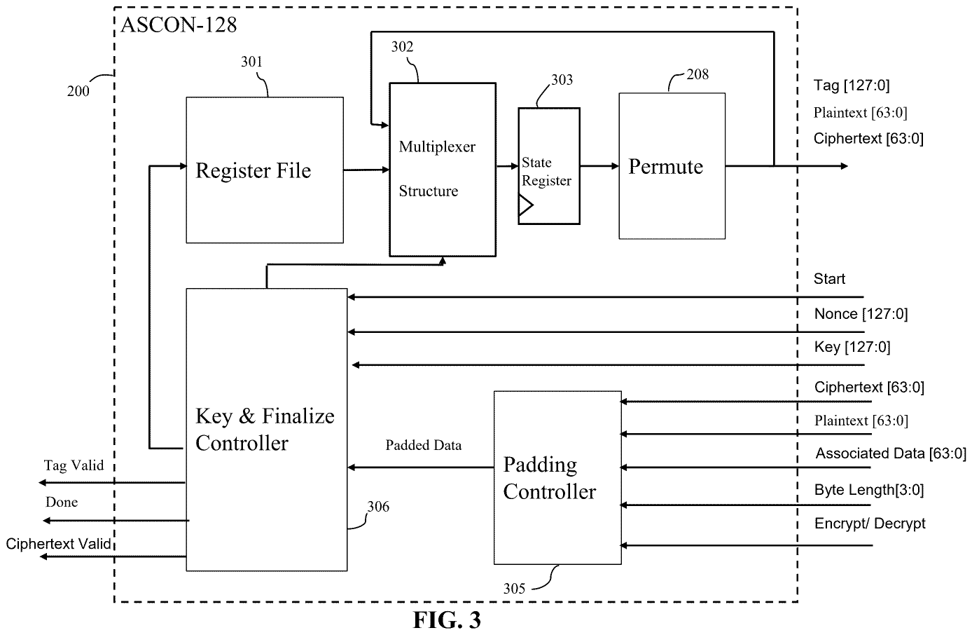

The present invention is an architecture and method to implement the Ascon cipher suite which includes authenticated encryption with associated data (AEAD) and hashing operations. Said another way and with reference to FIGS. 2-3, the present invention provides an area-efficient cryptosystem hardware architecture operably configured to execute ASCON algorithms by providing a computer chip (represented schematically with numeral 200) including an ASCON block operably configured to execute ASCON algorithms, having at least one register file operably configured to store a plurality of ASCON algorithm input data, having a controller 306, having a three-tiered multiplexor structure operably configured through the controller 306 to selectively receive from the plurality of ASCON algorithm input data and each generates permutation round input, and having a permutation module 208 operably configured to receive the permutation round input from the three-tiered multiplexor structure, execute a permutation round, and to generate permutation round output for utilization in the execution of the ASCON algorithms. In one embodiment, the plurality of ASCON algorithm input data includes or may consist of ciphertext, associated data, initialization vector, plaintext, key, and nonce.

As such, the architecture and method of the present invention aim to implement Ascon efficiently and securely than any known hardware architectures and methods. Efficiency in this invention is achieved thanks to the low-area design—specifically, a novel multiplexor architecture and the optional elimination of the state register. The architecture is secure against differential power analysis (DPA) attacks as well as simple power analysis (SPA) and timing attacks. Security against DPA is achieved using domain-oriented masking (DOM) with the novel use of the DOM pipeline register instead of the main ASCON state register which saves area while preserving security. Security against SPA and timing attacks is achieved since we use a wide datapath and constant-time implementation.

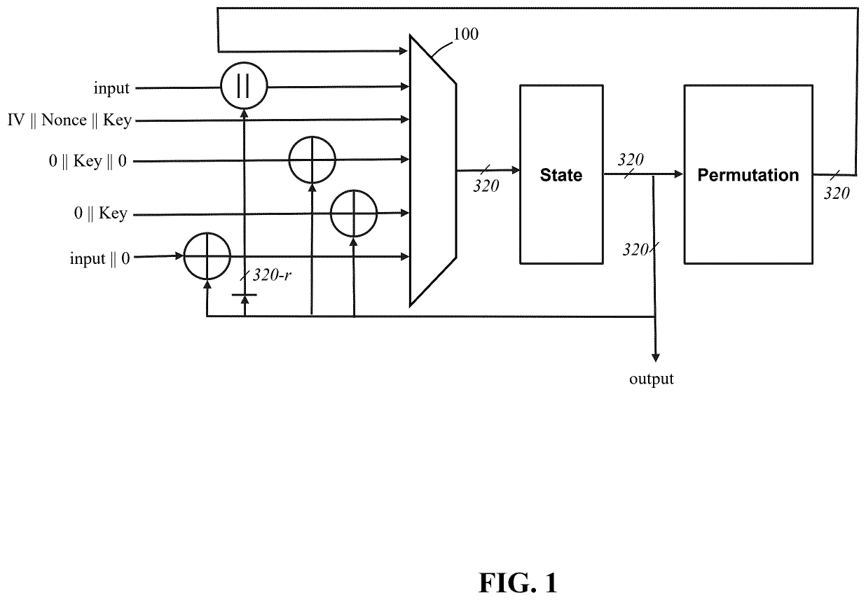

FIG. 1 depicts an exemplary prior-art architecture of ASCON where a single large multiplexor is used to select the input of the permutation and the state register that stores the 320-bit ASCON state separate from the permutation unit. FIG. 2 illustrates the architecture of the multiplexors used to select the permutation inputs in the present invention. Instead of a single large multiplexor 100, as disclosed in the prior art, the multiplexor configuration is segmented into three smaller multiplexors 201-203 each responsible for selecting among the possible inputs for a segment of the state. The multiplexors take input from the data in the Register File and select the input for the Permute unit/module 208.

More specifically, the architecture may include a plurality of logic gates 204, 205, 206 operably coupled to the three-tiered multiplexor structure 201, 202, 203, respectively, and are configured to receive at least one of the plurality of ASCON algorithm input data and the permutation round output. In a preferred embodiment, the first XOR gate 204 is operably coupled to a first multiplexor 201 of the three-tiered multiplexor structure, configured to receive at least one of the plurality of ASCON algorithm input data (preferably a key) and the permutation round output. The XOR gate 204 is configured to generate a first XOR gate output 210, wherein the first multiplexor 201 is operably configured to selectively and directly receive from the plurality of ASCON algorithm input data in the at least one register file, directly from the permutation round output, and directly from the first XOR gate output to generate a first permutation round input. The second XOR gate 205 is operably coupled to a second multiplexor 202 of the three-tiered multiplexor structure and is configured to receive at least one of the plurality of ASCON algorithm input data (preferably the key) and the permutation round output. The second XOR gate 205 is beneficially configured to generate a second XOR gate output 212, wherein the second multiplexor 202 is operably configured to selectively and directly receive from the plurality of ASCON algorithm input data in the at least one register file, directly from the permutation round output, and directly from the second XOR gate output 212 to generate a second permutation round input. The third XOR gate 206 is operably coupled to a third multiplexor 203 of the three-tiered multiplexor structure and is configured to receive at least one of the plurality of ASCON algorithm input data (preferably plaintext and/or associated data) and the permutation round output. The third XOR gate 206 is configured to generate a third XOR gate output 214, wherein the third multiplexor 203 is operably configured to selectively and directly receive from the plurality of ASCON algorithm input data (preferably initialization vector (IV) and/or ciphertext) in the at least one register file, directly from the permutation round output, and directly from the second XOR gate output 214 to generate a third permutation round input.

Each of the first, second, and third permutation round inputs are configured to form the permutation round input for the permutation module 208. In one embodiment, the permutation round input is 320 bits numbered from 0 to 319, wherein the first multiplexor 201 is operably configured to generate the first permutation round input with bits numbered from 0 to 127, the second multiplexor 202 is operably configured to generate the second permutation round input with bits numbered from 128 to 255, and the third multiplexor 203 is operably configured to generate the third permutation round input with bits numbered from 256 to 319, thereby enabling a low-area efficient design.

FIG. 3 shows the top-level architecture of ASCON-128 block according to the present invention and depicts the major units used to store data and carry out computations. Additionally, FIG. 3 illustrates how the data flows between the major units and depicts the optional instantiation of the present invention without the use of masking. In the case of disabling masking, no data shares are used hence, no duplication in computation units or storage units is needed. Because no duplication is used, the area is minimal, however, no power analysis security is provided. This instantiation is suitable for designs where power analysis is not practical, e.g., when there is significant physical security and the attacker cannot collect power measurements.

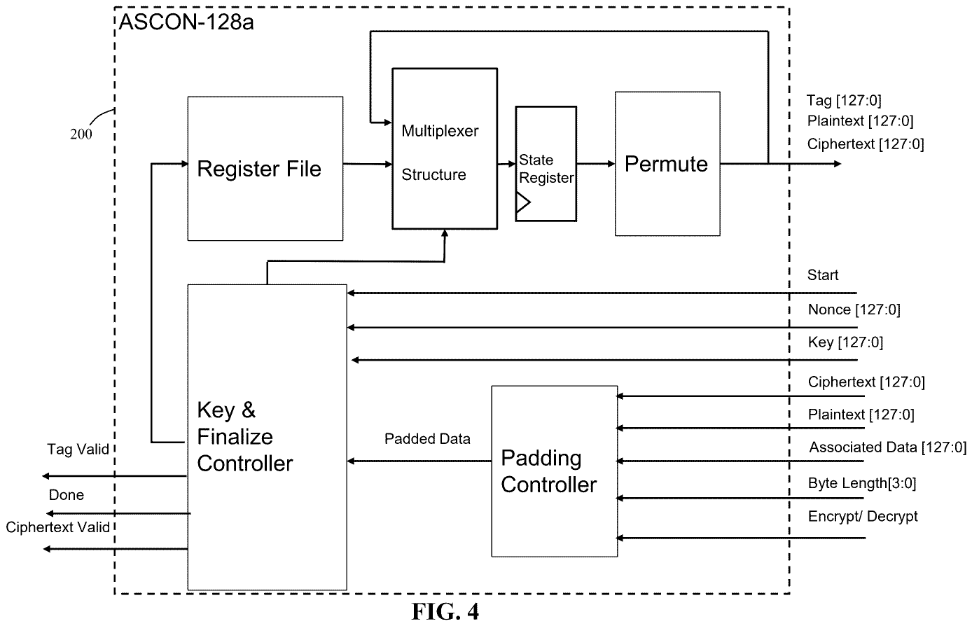

FIG. 4 shows the same architecture shown in FIG. 3 except that now it supports ASCON-128a. The main difference between ASCON-128 and ASCON-128a is that ASCON-128 uses 64-bit data blocks while ASCON-128a uses 128-bit blocks. Additionally, the number of permutation rounds is different.

FIG. 5 depicts the present invention when masking is enabled. When masking is enabled, all sensitive data is split into randomized shares. A value X can be split into shares X₁ . . . Xₙ such that the sum of the shares X₁ . . . Xₙ equals X. In this architecture, we use d+1 shares where d is the masking order. The computation units are modified to process these shares which require duplication and the redesign of non-linear units. In FIG. 5, the units that are duplicated or updated are shown using dashed lines. The architecture is designed in such a way that control units that do not include any sensitive data are instantiated as separate units so they are not duplicated with the units that process sensitive data. All sensitive inputs are split into shares and duplicated d+1 times. FIG. 3 and FIG. 5 illustrate the comparison between the standard and the masked data flow and block diagrams of ASCON. In the masked version, the increment in components such as multiplexors, state registers, and permutation blocks corresponds to the masking degree.

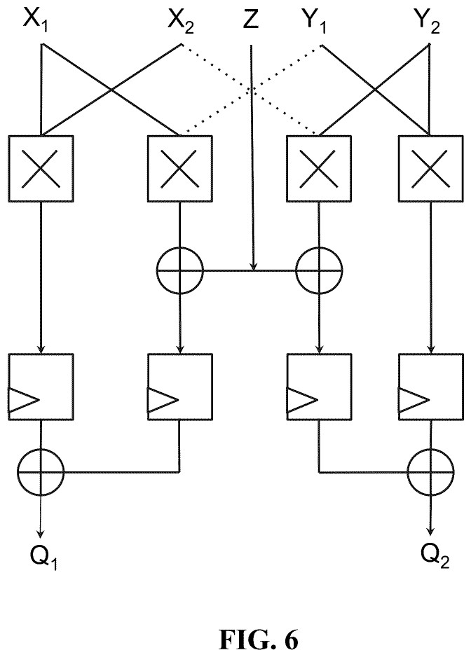

FIG. 6 illustrates the DOM AND gates which are internal to the masked Permute/permutation unit/module 208. The DOM AND gates perform the logic AND operation needed for the ASCON non-linear layer in a side-channel-secure way. In DOM AND gates, there are two types of registers, the first is required to provide security by stopping glitches in hardware, while the second set of registers is optional and can be used for pipelining. We chose to use the DOM AND gate registers to allow the option of storing the ASCON state in this register layer. The required and pipeline registers together form a layer of registers that are used to store the ASCON state. Said another way, the permutation module 208 includes a plurality of DOM AND gates internal to the permutation module 208 and that are operably configured to receive the permutation round input during the permutation round and a plurality of pipeline registers internal to the permutation module and operably configured to receive and store the permutation round input during the permutation round. The plurality of DOM AND gates and the plurality of pipeline registers are operably configured to receive the permutation round input without the permutation round input passing through a state register block.

The top-level architecture of our design is shown in FIG. 3. This hardware architecture is designed to work as a coprocessor or accelerator where a main processor can offload encryption, decryption, and hash operations to our coprocessor to speed up operations and lower energy consumption. We utilize a novel architecture to reduce the area of the design while at the same time, having a high performance. The low area is due to a streamlined architecture of the multiplexing logic used to select the permutation inputs and the usage of the DOM AND gate pipeline registers to serve the purpose of the main state register.

The design implements the ASCON suit including AEAD, HASH, and XOF. In the case of AEAD encryption, the coprocessor receives the key, nonce, AD, and, plaintext and outputs the ciphertext and a tag. In the case of AEAD decryption, it receives the key, nonce, AD, ciphertext, and a tag and outputs the plaintext if the authentication is successful. In the case of HASH and XOF, the coprocessor receives data blocks and outputs a digest.

Internally, the major components of our design are the Padding Controller 305, the Key and Finalize Controller 306, the Register File 301, the permutation input Multiplexor Structure 302, the State Register 303, and the Permute Unit 304. The Padding Controller 305 pads the ciphertext/plaintext and associated data into full blocks. ASCON-128 AEAD expects 64-bit blocks while ASCON-128a expects 128-bit blocks. The Padding Controller 305 appends a ‘1’ and the smallest number of zeros so that the number of bits is a multiple of the rate r. The Padding Controller takes as input the plaintext/ciphertext, the associated data, the number of valid bytes in the current input, and the Encrypt/decrypt control signal. The Padding Controller outputs the input data with padding to a full block if needed.

The Key and Finalize Controller 306 is the main controller used in the architecture of the current invention. It performs the handshaking for input and output and controls the datapath multiplexors and registers. The Key and Finalize Controller takes as input the start control signal, key, and nonce. It also receives the padded data from the Padding Controller. The Key and Finalization Controller outputs the padded data, and the Tag Valid, Done, and Ciphertext Valid handshake signals. It also outputs control signals to switch the multiplexors and enable the datapath registers. Internally the Key and Finalize Controller includes a finite state machine (FSM) that implements state transitions based on the current state and input and is synchronized using a clock signal. Additionally, the FSM sets control signals based on the current state and input.

The Register File 301 is used as a temporary storage for the key, nonce, ciphertext/plaintext, and the initialization vector before they are sent to the Permute Unit 304. The Register File comprises six 128-bit registers to store the data mentioned above.

With reference to FIG. 2, a set of three multiplexors selects the appropriate data from the register file and supplies it as input to the Permute unit. The first multiplexor 201 takes the Nonce, and Permute Output XORed with the Key, and Permute Output, and sets permutation input bits 0 . . . 127. The second multiplexor 202 takes the key and Permute Output XORed with the Key, and Permute Output, and sets permutation input bits 128 . . . 255. The third multiplexor 203 takes Plaintext XORed with the Permute Output, or AD XORed with the Permute Output, and the IV, or the Ciphertext, and the Permute Output and sets Permuation Input bits 256 . . . 319.

With reference to FIG. 3, The Permute unit 304 performs the ASCON permutation round 12, 8, or 6 times depending on the phase and the ASCON variant. The Permute unit performs the ASCON permutation round which comprises round constant addition, substitution layer, and linear layer. The Permute unit is designed for arbitrary masking order which is configurable using a parameter D.

Our architecture can be instantiated to resist arbitrary orders of differential power analysis (DPA). This is done by setting parameter D at synthesis time. The design uses Domain-oriented masking (DOM) for masking with D+1 shares of data. The parameter D affects how the datapath units are duplicated and configured to support the required protection order. All sensitive data used in the design is split into shares that are independent of each other and the sum of the shares equals the sensitive value. The linear part of the Permute unit is duplicated depending on the security order D, while the non-linear layer is configured to support the given security order.

The masked non-linear layer internal to the masked permutation 504 comprises a plurality of DOM AND gates which use a register layer 505 for security and pipelining. We utilize this layer to store the ASCON state bits to avoid using a separate state register 503 to store the state to save the area. Specifically, the State Register 503 which is shown between the multiplexor and the Permute unit in FIG. 5, can be removed and the registers in the Permute unit non-linear layer are used instead to save area.

Although a specific order of executing the process steps has been disclosed, the order of executing the steps may be changed relative to the order shown in certain embodiments. Also, two or more steps or block shown or described as occurring in succession may be executed concurrently or with partial concurrence in some embodiments. Certain steps may also be omitted for the sake of brevity. In some embodiments, some or all of the process steps can be combined into a single process.

Also, various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the above described features.

1. An area-efficient cryptosystem hardware architecture operably configured to execute ASCON algorithms comprising:
a computer chip including an ASCON block operably configured to execute ASCON algorithms, having at least one register file operably configured to store a plurality of ASCON algorithm input data, having a controller, having a three-tiered multiplexor structure operably configured through the controller to selectively receive from the plurality of ASCON algorithm input data and each generates permutation round input, and having a permutation module operably configured to receive the permutation round input from the three-tiered multiplexor structure, execute a permutation round, and to generate permutation round output for utilization in the execution of the ASCON algorithms.

2. The area efficient cryptosystem hardware architecture according to claim 1, wherein the at least one register file includes the plurality of ASCON algorithm input data further comprising:
ciphertext, associated data, initialization vector, plaintext, key, and nonce.

3. The area-efficient cryptosystem hardware architecture according to claim 2, further comprising:
a plurality of logic gates operably coupled to the three-tiered multiplexor structure and configured to receive at least one of the plurality of ASCON algorithm input data and the permutation round output.

4. The area-efficient cryptosystem hardware architecture according to claim 2, further comprising:
a first XOR gate operably coupled to a first multiplexor of the three-tiered multiplexor structure, configured to receive at least one of the plurality of ASCON algorithm input data and the permutation round output, and configured to generate a first XOR gate output, wherein the first multiplexor is operably configured to selectively and directly receive from the plurality of ASCON algorithm input data in the at least one register file, directly from the permutation round output, and directly from the first XOR gate output to generate a first permutation round input;
a second XOR gate operably coupled to a second multiplexor of the three-tiered multiplexor structure, configured to receive at least one of the plurality of ASCON algorithm input data and the permutation round output, and configured to generate a second XOR gate output, wherein the second multiplexor is operably configured to selectively and directly receive from the plurality of ASCON algorithm input data in the at least one register file, directly from the permutation round output, and directly from the second XOR gate output to generate a second permutation round input; and
a third XOR gate operably coupled to a third multiplexor of the three-tiered multiplexor structure, configured to receive at least one of the plurality of ASCON algorithm input data and the permutation round output and configured to generate a third XOR gate output, wherein the third multiplexor is operably configured to selectively and directly receive from the plurality of ASCON algorithm input data in the at least one register file, directly from the permutation round output, and directly from the third XOR gate output to generate a third permutation round input, the first, second, and third permutation round input forming the permutation round input.

5. The area-efficient cryptosystem hardware architecture according to claim 4, wherein the first XOR gate is configured to receive a key and the Permute output, the first multiplexor is operably configured to selectively and directly receive the nonce, the first XOR gate output, and the Permute output, the second XOR gate is configured to receive the key and the Permute output, the second multiplexor is operably configured to selectively and directly receive the key and the second XOR gate output and the Permute output, and the third XOR gate is configured to receive the plaintext or the associated data, and the Permute output, the third multiplexor is operably configured to selectively and directly receive the ciphertext, the initialization vector, the output of the third XOR gate, and the Permute output.

6. The area efficient cryptosystem hardware architecture according to claim 5, wherein the permutation round input is 320 bits numbered from 0 to 319, the first multiplexor is operably configured to generate the first permutation round input with bits numbered from 0 to 127, the second multiplexor is operably configured to generate the second permutation round input with bits numbered from 128 to 255, and the third multiplexor is operably configured to generate the third permutation round input with bits numbered from 256 to 319.

7. The area efficient cryptosystem hardware architecture according to claim 1, wherein the permutation round input generated from the three-tiered multiplexor structure is 320 bits numbered from 0 to 319 and further comprising:
a first multiplexor of the three-tiered multiplexor structure operably configured to generate a first permutation round input with bits numbered from 0 to 127;
a second multiplexor of the three-tiered multiplexor structure operably configured to generate a second permutation round input with bits numbered from 128 to 255; and
a third multiplexor of the three-tiered multiplexor structure operably configured to generate a third permutation round input with bits numbered from 256 to 319.

8. The area efficient cryptosystem hardware architecture according to claim 1, wherein the permutation module further comprises:
a plurality of DOM AND gates internal to the permutation module and operably configured to receive the permutation round input during the permutation round; and
a plurality of pipeline registers internal to the permutation module and operably configured to receive and store the permutation round input during the permutation round.

9. The area-efficient cryptosystem hardware architecture according to claim 8, wherein the plurality of DOM AND gates and the plurality of pipeline registers are operably configured to receive the permutation round input without the permutation round input passing through a state register block.

10. An area-efficient cryptosystem hardware architecture operably configured to execute ASCON algorithms comprising:
a computer chip including an ASCON block operably configured to execute ASCON algorithms, having at least one register file operably configured to store a plurality of ASCON algorithm input data, having a controller, having a multiplexor structure operably configured through the controller to selectively receive from the plurality of ASCON algorithm input data and each generate permutation round input, and having a permutation module:
operably configured to execute a permutation round;
including a plurality of DOM AND gates internal to the permutation module and operably configured to receive the permutation round input during the permutation round;
including a plurality of pipeline registers internal to the permutation module and operably configured to receive and store the permutation round input during the permutation round; and
operably configured to generate permutation round output for utilization in the execution of the ASCON algorithms.

11. The area efficient cryptosystem hardware architecture according to claim 10, wherein the plurality of DOM AND gates and the plurality of pipelined registers are operably configured to receive the permutation round input without the permutation round input passing through a state register block.

12. The area efficient cryptosystem hardware architecture according to claim 10, further comprises:
a three-tiered multiplexor structure operably configured through the controller to selectively receive from the plurality of ASCON algorithm input data and each generate permutation round input, wherein the pluralityf DOM AND gates and the plurality of pipeline registers are operably configured to receive the permutation round input from the three-tiered multiplexor structure.

13. The area efficient cryptosystem hardware architecture according to claim 12, wherein the at least one register file includes the plurality of ASCON algorithm input data further comprising:
ciphertext, associated data, initialization vector, plaintext, key, and nonce.

14. The area efficient cryptosystem hardware architecture according to claim 13, further comprising:
a plurality of logic gates operably coupled to the three-tiered multiplexor structure and configured to receive at least one of the plurality of ASCON algorithm input data and the permutation round output.

15. The area efficient cryptosystem hardware architecture according to claim 12, further comprising:
a first XOR gate operably coupled to a first multiplexor of the three-tiered multiplexor structure, configured to receive at least one of the plurality of ASCON algorithm input data and the permutation round output, and configured to generate a first XOR gate output, wherein the first multiplexor is operably configured to selectively and directly receive from the plurality of ASCON algorithm input data in the at least one register file, directly from the permutation round output, and directly from the first XOR gate output to generate a first permutation round input;
a second XOR gate operably coupled to a second multiplexor of the three-tiered multiplexor structure, configured to receive at least one of the plurality of ASCON algorithm input data and the permutation round output, and configured to generate a second XOR gate output, wherein the second multiplexor is operably configured to selectively and directly receive from the plurality of ASCON algorithm input data in the at least one register file, directly from the permutation round output, and directly from the second XOR gate output to generate a second permutation round input; and
a third XOR gate operably coupled to a third multiplexor of the three-tiered multiplexor structure, configured to receive at least one of the plurality of ASCON algorithm input data and the permutation round output, and configured to generate a third XOR gate output, wherein the third multiplexor is operably configured to selectively and directly receive from the plurality of ASCON algorithm input data in the at least one register file, directly from the permutation round output, and directly from the third XOR gate output to generate a third permutation round input, the first, second, and third permutation round input forming the permutation round input.

16. The area efficient cryptosystem hardware architecture according to claim 15, wherein the first XOR gate is configured to receive the key and the permutation output, the first multiplexor is operably configured to selectively and directly receive the nonce, the first XOR gate output, and the permutation output, the second XOR gate is configured to receive the key and the permutation output, the second multiplexor is operably configured to selectively and directly receive the key, the second XOR gate output and the permutation output, the third XOR gate is configured to receive the plaintext or the associated data, and the permutation output, the first multiplexor is operably configured to selectively and directly receive the third XOR gate output, the initialization vector, the ciphertext, and the permutation output.

17. The area efficient cryptosystem hardware architecture according to claim 16, wherein the permutation round input is 320 bits numbered from 0 to 319, the first multiplexor is operably configured to generate the first permutation round input with bits numbered from 0 to 127, the second multiplexor is operably configured to generate the second permutation round input with bits numbered from 128 to 255, and the third multiplexor is operably configured to generate the third permutation round input with bits numbered from 256 to 319.

18. The area efficient cryptosystem hardware architecture according to claim 12, wherein the permutation round input generated from the three-tiered multiplexor structure is 320 bits numbered from 0 to 319 and further comprising:
a first multiplexor of the three-tiered multiplexor structure operably configured to generate a first permutation round input with bits numbered from 0 to 127;
a second multiplexor of the three-tiered multiplexor structure operably configured to generate a second permutation round input with bits numbered from 128 to 255; and
a third multiplexor of the three-tiered multiplexor structure operably configured to generate a third permutation round input with bits numbered from 256 to 319.
